(19) United States
(12) Patent Application Publication
(10) Pub. No.: US 2014/0184380 A1
(43) Pub. Date: Jul. 3, 2014

(54) MULTI-STATE MEMORY RESISTOR DEVICE AND METHODS FOR MAKING THEREOF

(71) Applicants: Varun Aggarwal, New Delhi (IN); Gaurav Gandhi, New Delhi (IN)

(72) Inventors: Varun Aggarwal, New Delhi (IN); Gaurav Gandhi, New Delhi (IN)

(21) Appl. No.: 13/988,901

(22) PCT Filed: Nov. 25, 2011
(86) PCT No.: PCT/IB2011/055304

§ 371 Date: Aug. 12, 2013

(30) Foreign Application Priority Data
Nov. 26, 2010 (IN) 2821/DEL/2010

(51) Int. Cl. H01C 10/10

(52) U.S. Cl. CPC H01C 10/10
USPC 338/13; 29/610.1

(57) ABSTRACT

In one aspect, the invention provides a method for making a multi-state memory resistor device. The method comprises providing a convertible component and inducing multiple state-dependent resistances on the convertible component to provide a multi-state memory resistor device. The convertible component is characterized by at least one of packing density, applied pressure, temperature, contact area or combinations thereof. The resistance from the multiple state-dependent resistances of the multi-state memory resistor device is a function of maximum current applied across the convertible component. In another aspect, the invention provides a multi-state memory resistor device comprising a convertible component, wherein the convertible component converts into a multi state memory resistor device having multiple state-dependent resistances when induced with a maximum current across the convertible component.

### TECHNICAL FIELD

The invention relates to a memory resistor device and more specifically to a multi-state memory resistor device.

### BACKGROUND

Resistive switching memories have shown promising characteristics for future generation non volatile memories and reconfigurable logic applications. These devices can be programmed between two or more resistance states based on the input applied across them. Recent introduction of memristor, also referred herein interchangeably as memory resistor, into the class of switching memories has further enhanced the prospects of resistive switching memories. Memristors are defined as any 2-terminal electronic device devoid of internal power source that is capable of switching between two resistances upon application of an appropriate voltage or current signal, and whose resistance state at any instant of time can be sensed by applying a relatively much smaller sensing signal. Furthermore, a pinched hysteresis loop in the graphical representation of the voltage vs. current characteristics of the device acts as the fingerprint for memristors.

Since the publication of memristor by Hewlett-Packard (HP) laboratories in 2008, there have been numerous attempts by researchers. Some of these memristors are a) Graphene Based Memristor (Jeong, H. Y. and Kim, J. Y. and Kim, J. W. and Hwang, J. O. and Kim, J. E. and Lee, J. Y. and Yoon, T. H. and Cho, B. J. and Kim, S. O. and Ruoff, R. S, “Graphene Oxide Thin Films for Flexible Nonvolatile Memory Applications”, Nano Letters, pp. 1625-1626, 2010)., NIST Flexible Memristor Gergel-Hackett et al (Gergel-Hackett, N., Hamadani, B., Dunlap, B., Suehle, J., Richter, C., Hacker, C. & Gundlach, D., “A flexible solution-processed memristor. IEEE Electron Dev. Lett. 30, 706-708., 2009) and TiO₂based memristor (Michelakis K, Prodromakis T, Toumazou C, Cost-effective fabrication of nanoscale electrode memristors with reproducible electrical response, Micro & Nano Letters, 2010, Vol: 5, Pages: 91-94).

HP's version of memristors are composed of a thin titanium dioxide film between two electrodes. Herein, the film includes dual layers, wherein one is a non-depleted layer and the other is a depleted layer with a slight depletion of oxygen. Applying a voltage to the memristor is thought to cause migration of the dopants between the doped and undoped regions that contributes to changing the electric resistance of the memristor. When all oxygen vacancies drift to an interface between the film and one electrode, the resistance of the film is maximum because there is no charge carrier inside the film.

The current available variations of memristors are characterized by one or more of the following problems: a) require expensive process to make; b) works at very small dimensions and hence require precise control; c) are precise or complex constructions; d) are charge controlled devices; e) shows single pinch hysteresis as a testimonial to them being memristive; f) shows simple bistable behavior.

Thus there is a need for memory resistor device that can be easily fabricated under facile conditions that can be used in a variety of conditions and situations.

### BRIEF DESCRIPTION

In one aspect, the invention provides a method for making a multi-state memory resistor device. The method comprises providing a convertible component and inducing multiple state-dependent resistances on the convertible component to provide a multi-state memory resistor device. The convertible component is characterized by at least one of packing density, applied pressure, temperature, contact area or combinations thereof. The resistance from the multiple state-dependent resistances of the multi-state memory resistor device is a function of maximum current applied across the convertible component in one exemplary implementation.

In another aspect, the invention provides a multi-state memory resistor device comprising a convertible component characterized by at least one of packing density, applied pressure, temperature, contact area or combinations thereof, wherein the convertible component converts into a multi state memory resistor device having multiple state-dependent resistances when induced with a maximum current across the convertible component, wherein a resistance from the multiple state-dependent resistances of the multi-state memory resistor device is a function of the maximum current.

In yet another aspect, the invention provides an electronic crossbar architecture comprising one or more multi-state memory resistor device as described herein.

In a further aspect, the invention provides an electronic circuit comprising a first electrode, a second electrode and a multi-state memory resistor device as described herein.

### DRAWINGS

These and other features, aspects, and advantages of the present invention will become better understood when the following detailed description is read with reference to the accompanying drawings in which like characters represent like parts throughout the drawings, wherein:

FIG. 1 is a flowchart representation showing exemplary steps in the method of the invention;

FIG. 2 shows the multi-state memory resistor device comprising iron filings as the convertible component;

FIG. 3 shows the multi-state memory resistor device comprising iron balls as the convertible component;

FIG. 4 shows the multi-state memory resistor device comprising iron-mercury as the convertible component;

FIG. 5 shows a Resistance State Map for the device consisting of ICM as convertible component as described in Example 2;

FIG. 6 shows the Voltage-Current characteristics for the device described in Example 2;

FIG. 7 shows the variation of current and voltage with respect to time; and

FIG. 8 shows the device from Example 2 forming an eight-pinched hysteresis loop.

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

As used herein a convertible component is a component for use in electrical and electronics circuitry, which exhibits a low resistance in its original state and can be induced to non-linear resistive states by different physical modes. An exemplary physical mode to induce non-linear resistive states includes but not limited to simple tapping of the component. Other such physical modes will become obvious to one skilled in the art and is contemplated to be within the scope of the invention.

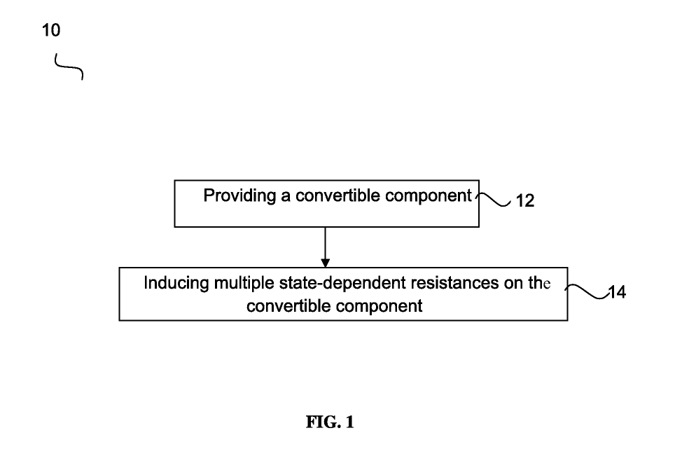

As noted herein, in one aspect, the invention provides a method for making a multi-state memory resistor device, interchangeably referred also as a memristor. FIG. 1 is a flowchart representation of the method of the invention, generally depicted by numeral 10. The method 10 comprises providing a convertible component, shown by numeral 12 in FIG. 1. The convertible component is characterized by at least one of packing density, applied pressure, temperature, contact area or combinations thereof. The convertible component is typically made of a metal having resistances in the range useful for different applications, which would be obvious to one skilled in the art. Different configurations of the convertible component are possible for example but not limited to, in one embodiment the convertible component is made of iron metal filings such as iron filings, in another exemplary embodiment, the convertible component is iron metal ball chain, and in yet another exemplary embodiment, the convertible component is made of two metals such as iron and mercury. In yet another non-limiting exemplary embodiment, the convertible component is made of various metallic springs, or it could be made of two-dimensional and three-dimensional metallic pieces of various shapes arranged or packed with a certain density. In yet another non-limiting configuration, the convertible component is a triangular metallic electrode in contact with a flat electrode. In yet another non-limiting configuration, the convertible component is a spherical electrode in contact with a flat electrode. It would be appreciated by those skilled in the art that still other configurations for the convertible component are possible that enable a small surface contact area, and are included within the scope of the invention.

In some embodiments, the convertible component is a combination of a first metal and a second metal. The first metal and the second metal are in direct or indirect contact with each other. In some embodiments either the first metal of second metal is in liquid form. The first metal is selected from a group consisting of mercury, iron, steel, tantalum, nickel, cobalt, manganese, chromium, aluminum, tin, lead, thallium, molybdenum, uranium, metals from platinum group, sodium, lithium, magnesium, zinc, cadmium, potassium, calcium, bismuth, antimony, copper, gold, alloys thereof, and combinations thereof. . The second metal is selected from a group consisting of iron, steel, tantalum, nickel, cobalt, manganese, chromium, aluminum, tin, lead, thallium, molybdenum, uranium, metals from platinum group, sodium, lithium, magnesium, zinc, cadmium, potassium, calcium, bismuth, antimony, copper, gold, alloys thereof, and combinations thereof. It would be appreciated by those skilled in the art that the first metal and second metal could be other combinations as well, and the examples provided herein are for illustrative purpose only.

The first metal and the second metal may be in direct contact with each other. The direct contact may be achieved through a point contact, a series of point contacts, a layer of contact like the one made between one metal being triangle with its one vertex in contact with other metal, which is flat or localized many point contacts like the one made between one metal being spherical and other metal being flat or across an interface between the two surfaces of the metal layers. The interface may occur over a distance ranging from about 1 nanometer to about 100 micrometers. These are non-limiting examples of the direct contact between the first metal and the second metal, and other configurations including both the first metal and the second metal as spheres or as triangles with their vertices in contact, or with at least one the first metal or the second metal in any geometric configuration that enables a point or a small surface area contact are also included within the scope of the invention. Alternately, the first metal and the second metal may be in indirect contact with each other. Indirect contact may occur at least partially through an intermediate layer. Thus, only a portion of the first metal may be in contact with the second metal directly while the remaining portion is in contact through an insulation layer, or the first metal is entirely in contact with an insulation layer, which is in turn in contact with the second metal. The intermediate layer useful in the invention is an insulation layer, which may be made from an oxide or sulphide of the first metal, an oxide or sulphide of the second metal, or combinations thereof in an exemplary non-limiting embodiment. Such layers may be formed in situ by the exposure of the metal to suitable reagents such as atmosphere or oxygen, or may be specifically applied onto the surface of the metal layers.

As mentioned earlier, the convertible component is characterized by at least one of packing density, applied pressure, temperature, contact area or combinations thereof. The nature of the characterization feature of the convertible component depends on a variety of factors, such as but not limited to, physical state, physical appearance, chemical composition, available surface area, and the like. Thus, in the case of iron filings, packing density would be a suitable characterizing feature, while for metals in the form of spheres, balls or films, contact area may be a characterizing feature. The exact form of characterizing feature suitable for a given convertible component will become obvious to one skilled in the art.

The convertible component may be a discrete component made independently in a suitable facility. Alternately, the convertible component may be integrated into a device as a co-existing component. Such devices may include, for example, but not limited to, a simple electronic circuit, an electronic circuit in crossbar architecture, logic circuits, memory devices, and so on. Other exemplary applications will become obvious to one of ordinary skill in the art, and is contemplated to be within the scope of the invention.

The method then comprises inducing multiple state-dependent resistances on the convertible component to provide a multi-state memory resistor device as depicted by numeral 14 in FIG. 1. In an exemplary non-limiting implementation, each acquired resistance from the multiple state-dependent resistances of the multi-state memory resistor device is a function of a state variable. In one example the state variable is a maximum current applied across the convertible component. It may be appreciated that besides maximum current there may be other techniques and state variables for inducing multiple resistance states and are included within the scope of the invention. In one embodiment, the multiple state-dependent resistances are induced by applying a threshold current corresponding to a voltage greater than a predefined voltage threshold value on the convertible component. Further, the multiple state-dependent resistances are also characterized by a constant maximum voltage in an exemplary implementation. In other implementations, the multiple state-dependent resistances may be characterized by fluctuating voltages, or by falling voltages. The nature of voltage will depend on the device in use and the manner in which the multiple states have been induced, and will become obvious to one skilled in the art without undue experimentation.

In one specific embodiment of a multi-state memory resistor device, the multiple state-dependent resistances are induced by excitation with a current greater than that is required to achieve threshold voltage. Once excited, the device will maintain resistance value when excited at currents lower than the current threshold. It is possible to switch between states by exciting the device using a current corresponding to a higher voltage.

One skilled in the art will also recognize that the direction will influence the resistance of the multi-state memory resistor device of the invention. Thus a current applied in a one direction will give rise to one resistance state while the same magnitude of current in the opposite direction will give rise to a different resistance state in the device.

The multiple state-dependent resistances induced into the multi-state memory resistor device of the invention can be reset. This act of resetting from one state to an original state can be achieved through mechanical means, electrical means, chemical means, or any other means known to one of ordinary skill in the art, and combinations thereof. In one specific embodiment, the multiple state-dependent resistances are electrically reversed. In another specific embodiment, the multiple state-dependent resistances of the convertible component are mechanically reset to the original state, such as shaking as in the case of a coherer device.

The multi-state memory resistor device of the invention can be fabricated at any dimension useful for a particular application. The device dimensions may range from about 1 nanometer to about 1 millimeter. The dimensions for the device may be length, width, height, thickness, and the like or combinations thereof to describe the device.

Thus, as noted herein, the invention provides a multi-state memory resistor device comprising a convertible component, which is characterized by at least one of packing density, applied pressure, temperature, contact area or combinations thereof, wherein the convertible component converts into a multi state memory resistor device having multiple state-dependent resistances. In a specific embodiment the multiple resistances are induced with a maximum current across the convertible component, wherein a resistance from the multiple state-dependent resistances of the multi-state memory resistor device is a function of the maximum current. It may also be noted here that the desirable resistance ratios are also achievable with the multi-state memory device, by using different input current and voltages in positive and negative cycles or directions. The resistance ratio as referred herein is the ratio between different stable resistance states the device can be configured and reconfigured electrically. This is extremely useful from practical implementation point of view where the resistance ratios of 1:1000 or 1:10,000 and the like are desirable.

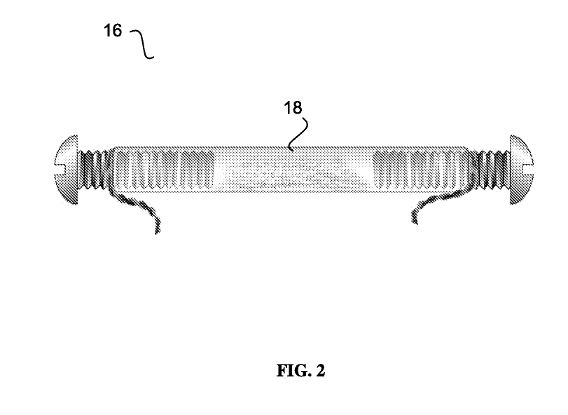

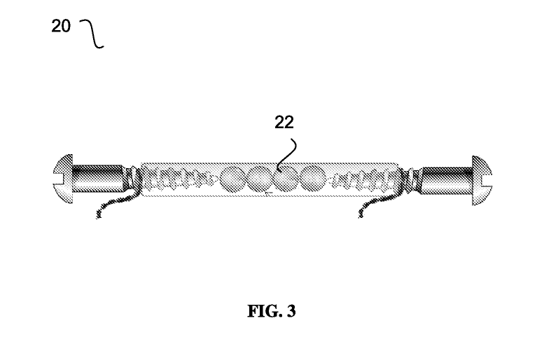

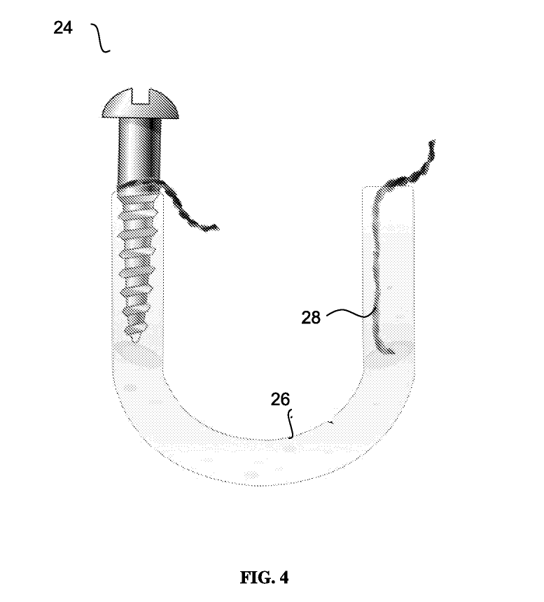

FIG. 2 shows the multi-state memory resistor device 16 built using iron filings (depicted by numeral 18) as the convertible component. FIG. 3 shows the multi-state memory resistor device 20 built using iron chains (depicted by numeral 22) as the convertible component. FIG. 4 shows a multi-state memory resistor device 24 built using a mercury layer 26 in contact with an iron layer 28. Other variations for making the multi-state memory resistor device will become obvious to one skilled in the art, and is contemplated to be within the scope of the invention.

The multi-state memory resistor device may be at least partially submerged in suitable fluids, such as water, water vapour, kerosene, petroleum, and the like, and appropriate combinations thereof. The fluids may be used to cool the device that may otherwise get heated. Alternately, the fluid may be used to increase conductivity. Other uses and considerations may be taken into account for choosing the fluid.

The device can be used as a class of memristive devices and can be used both for circuit designing as well as implementing integrated circuits. Thus, in yet another aspect, the invention provides a crossbar array comprising one or more multi-state memory resistor device of the invention. A crossbar array as defined herein is an array of switches that can connect each wire in one set of parallel wires to every member of a second set of parallel wires that intersects the first set.

In a further aspect, the invention provides an electronic circuit that comprises the multi-state memory resistor device of the invention. The electronic circuit will also comprise a first electrode and a second electrode that connects the multi-state memory resistor device to other components of the circuit. The electronic circuit may be part of an electronic material that can be used in portable electronic devices, sensors, displays, or the like. Other exemplary situations where the multi-state memory resistor device of the invention is useful include, but not limited to, two-terminal circuit elements that are useful as memory devices, or for logic functionality. The method of making the device and the multi-state memory resistor device as described herein provides several advantages. The method allows for a simple construction methodology that allows for facile construction without the use of expensive equipment and labour intensive techniques. Further, a micro-scale or even a macro-scale device can be constructed using the methods described herein, which is in direct contrast to published literature (D. Strukov, G. Snider, D. Stewart, and R. Williams, “The missing memristor found” Nature, vol. 453, no. 7191, pp. 80-83, 2008) which states that nano-scales are required to achieve memory resistive behavior. Also precisely controlled geometries are not required for obtaining memory resistive behavior, as opposed to some of the described devices in prior art (for example US2011204947A1 or US2011096589A1.)

The method and device as described herein can aid research and can also be used into pedagogy of circuit design that provides opportunity to design various novel analog and digital systems. Further, apart from the usual application of memristors in resistive-RAMs and cross-bar architecture or novel applications like hardware sorting, etc., the multi-state memory resistor device of the invention will enable experimenting, investigating and teaching memristors. This had been a big challenge in the advancement of the field (J. Albo-Canals and G. E. Pazienza. How to teach memristors in EE undergraduate courses. In Circuits and Systems (ISCAS), IEEE International Symposium on, pages 345-348, 2011).

### EXAMPLES

Three different multi-state memory resistor devices were constructed as described in the Examples given herein. Each device was subjected to a current in the range of −0.003 Amperes to 0.003 Amperes. The threshold voltage (Vₜₕ) was found to be approximately 1V. Initial resistance in different experiments was found to be between 45 Kilo ohms to 100 Kilo ohms.

### Example 1

A multi-state memory resistor device comprising Iron Filing Memristor (IFM) was prepared in the following manner: A 5 cm long, 0.5 cm diameter cylindrical PVC tube open at both ends was filled with rusted iron filings of size less than 0.5 mm (irregular size) such that the tube is filled with 4 cm of iron filings. The tube was then sealed with two rusted screws at both the ends and connected those screws with metal wires to be connected to measuring devices. A slight pressure was applied at both the ends.

### Example 2

A multi-state memory resistor device comprising Iron Chain Memristor (ICM) was prepared in the same manner as that described in Example 1, except that iron filings of Example 1 were replaced by 4 steel balls of 5 mm diameter. A slight pressure was applied at both the ends.

### Example 3

A multi-state memory resistor device comprising Iron Mercury Memristor (IMM) was prepared in the following manner: A U-shape PVC pipe of 0.5 cm diameter and 12 cm length was filled with 10 cm of mercury. A metallic connecting wire was dipped on one side of the U-tube while an iron screw connected to connecting wire was dipped at another side. A slight pressure was applied on the screw.

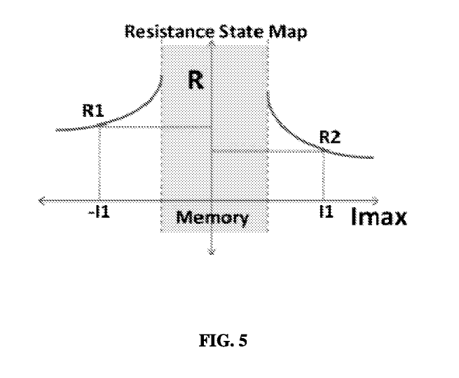

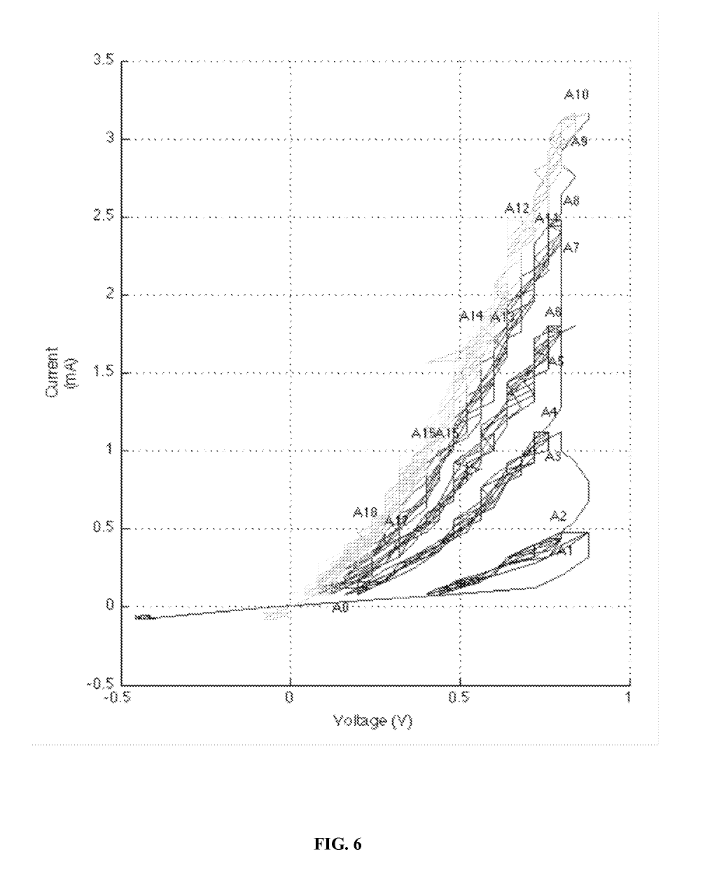

The behavior of the ICM has been provided here as reference. FIG. 5 shows a Resistance State Map for the device consisting of ICM as convertible component as described in Example 2, wherein the horizontal axis refers to maximum current flown while the vertical axis is the voltage across the device. FIG. 6 shows the Voltage-Current characteristics for the device described in Example 2. These devices, in their nonlinear mode, were activated by different kinds of current-mode input signals and their transient behaviour was recorded. The devices described in Examples 1, 2 and 3 exhibited three distinct behaviors: Cohering action, maximum current controlled state-dependent resistance, and bistable resistive RAM behavior.

### OBSERVATIONS

Cohereing Action:

All the three devices were initially tapped to configure them in a high resistance nonlinear state. For any input current leading to a voltage below a specific voltage threshold Vₜₕ, they continued to exhibit the high resistance state. The non-linear resistance became asymmetric given a DC voltage bias and thus demodulated a signal. Whereas device IMM readily shows a moderate non-linear resistance that can be used for demodulation, devices IFM and ICM required adjustment to do so. Due to this reason, IMM has been historically used for demodulation, but not the others. In this region the device remembers whatever (nonlinear) resistance it had before it got into this region and continues to exhibit the same.

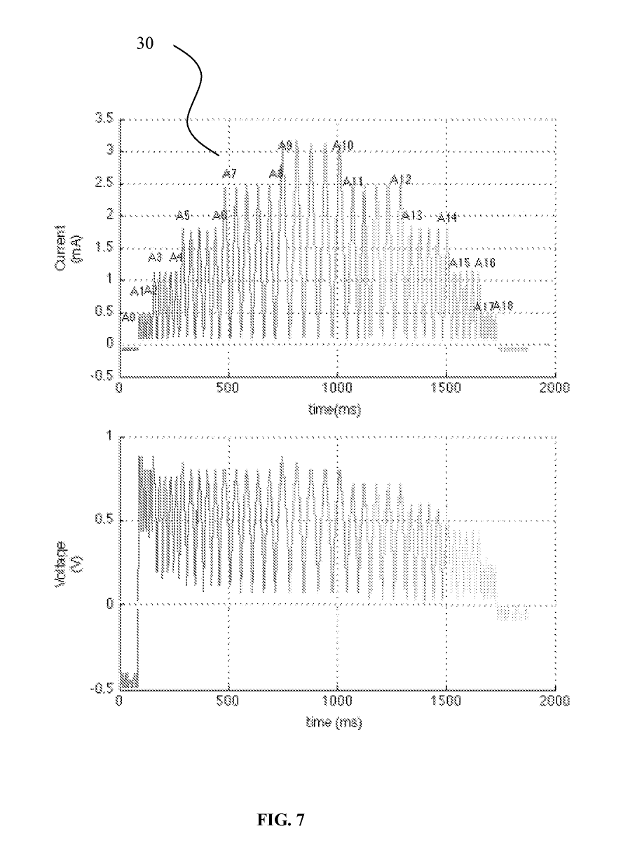

At a threshold current value Iₜₕ, corresponding to a voltage higher than Vₜₕ, the resistance of the device fell sharply and the device exhibited linear conductance. Once the device took this new state, it maintained the said resistance on excitation by current below Iₜₕ. This is shown in FIG. 7, where the device coheres at the point depicted by numeral 30. The defining characteristic of the cohering action is that the device cannot be reset to resistance less than that at 30 electrically.

### Maximum Current Controlled State-Dependent Resistance

Once formed by cohering action, the device exhibited a state-dependent resistance, the state variable being the maximum current (Iₘₐₓ) that has flowed through it, which can be mathematically represented as Rₜ=f([Iₘₐₓ]₀₋ₜ). The resistance decreased with every input current pulse of higher peak value. It is observed that the resistance value adjusts such that the maximum voltage across the device remains practically constant to Vₜₕ. This behaviour is akin to that of a diode but unlike a diode, the device remembers its changed resistance when taken to lower voltage levels. This behaviour is also shown graphically in FIG. 7. As the device is exposed to pulses of subsequently larger peak voltage, it sets itself to new resistance values. It may also be noted that the resistance remains nonlinear nonetheless. Thus, the device behaves like a state dependent resistance, the state variable being Iₘₐₓ,.

### Bistable Resistive RAM

The behaviours just discussed are the one-sided behavior of the device. It should be noted here that the resistance of the device is a function of the magnitude of Iₘₐₓ for either directions of current. However, even though ICM and IFM are perceptually symmetric, the state map of the resistance as a function of Iₘₐₓ differs for the two possible directions of current. This can be mathematically stated as:

Let Rₚ₁=f(_{magnitude}([Iₘₐₓ₊]₀₋ₜ))=I₁), Rₙ₁=f(_{magnitude}([Iₘₐₓ₋]₀₋ₜ))=I₁),

### Then Rₚ₁≠Rₙ₁

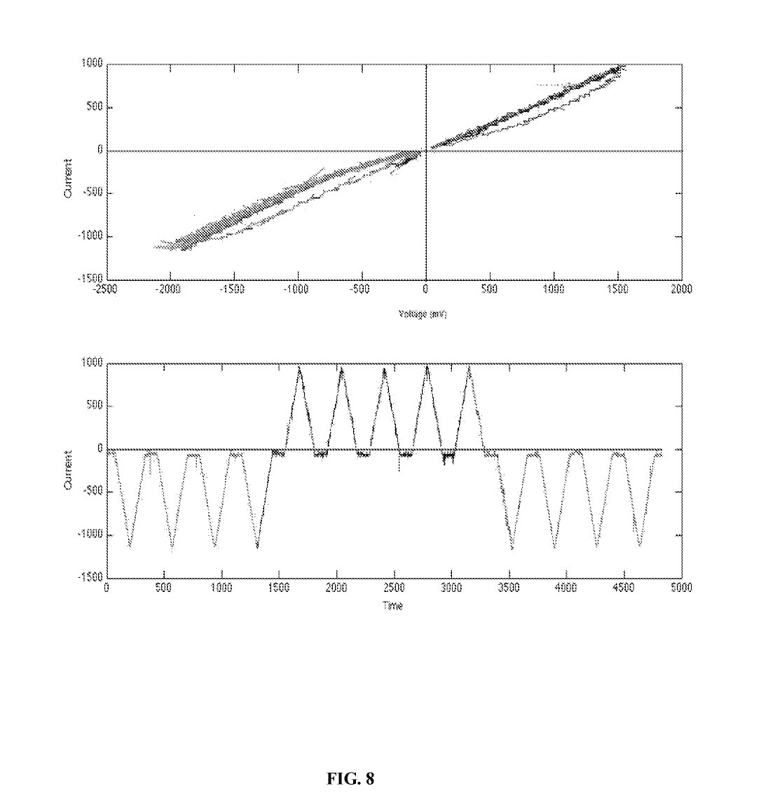

i.e. Rₚ₁ is the resistance of the device when activated by a maximum current of I₁ in positive direction, Rₙ₁ is a resistance when activated by a maximum current of I₁ in the negative direction. f(_{magnitude}([I_{max+]}₀₋ₜ)) implies the maximum current the device has experienced between time=0 to time=t. This gives rise to interesting device dynamics exhibited by the device. When activated with any two-sided current input, the device gets programmed into one state in the positive cycle and a different state in the negative cycle. It keeps oscillating between these two states, forming an eight-shaped pinched hysteresis loop, shown in FIG. 8. These resistance states are stable states and the resistance retains its value in absence of any excitation or if excited in the memory state, as previously defined.

While only certain features of the invention have been illustrated and described herein, many modifications and changes will occur to those skilled in the art. It is, therefore, to be understood that the appended claims are intended to cover all such modifications and changes as fall within the true spirit of the invention.

We claim:

1. A method for making a multi-state memory resistor device, wherein the method comprises:
providing a convertible component characterized by at least one of packing density, applied pressure, temperature, contact area or combinations thereof; and
inducing multiple state-dependent resistances on the convertible component to provide a multi-state memory resistor device.

2. The method of claim 1 wherein a resistance from the multiple state-dependent resistances of the multi-state memory resistor device is a function of a variable state.

3. The method of claim 2 wherein the variable state is a maximum current applied across the convertible component.

4. The method of claim 1 wherein the inducing the multiple state-dependent resistances is by applying a threshold current corresponding to a voltage greater than a predefined voltage threshold value on the convertible component.

5. The method of claim 1 wherein the convertible component is at least one of: a plurality of metal filings, at least two metal balls in contact with each other, and a combination of a first metal and a second metal, wherein the first metal and the second metal are in direct or indirect contact.

6. The method of claim 5 wherein the first metal is mercury and the second metal is selected from a group consisting of iron, steel, tantalum, nickel, cobalt, manganese, chromium, aluminum, tin, lead, thallium, molybdenum, uranium, metals from platinum group, sodium, lithium, magnesium, zinc, cadmium, potassium, calcium, bismuth, antimony, copper, gold, alloys thereof, and combinations thereof.

7. The method of claim 5 wherein the contact between the first metal and the second metal is indirect through an insulation layer made from an oxide or sulphide of the first metal, an oxide or sulphide of the second metal, or combinations thereof.

8. The method of claim 1 wherein the convertible component is at least one of a discrete component or an integrated chip component.

9. The method of claim 1 wherein a two-sided current input applied on the multi-state memory device yields one resistance state in a positive cycle and another resistive state in a negative cycle.

10. The method of claim 1 wherein the multi-state memory resistor device is a bistable resistive RAM device, wherein the resistance of the multiple state memory resistor device is a function of maximum current applied across the convertible component in either directions.

11. The method of claim 1 wherein the multi-state memory resistor device has dimensions ranging from 1 nanometer to about 1 millimeter.

12. The method of claim 1 wherein the multiple state-dependent resistances are electrically reversible.

13. The method of claim 1 further comprising resetting the convertible component to an original state.

14. The method of claim 1 wherein the multi-state memory resistor device is characterized by a constant maximum voltage at multiple state-dependent resistances.

15. A multi-state memory resistor device comprising:
a convertible component characterized by at least one of packing density, applied pressure, temperature, contact area or combinations thereof, wherein the convertible component converts into a multi state memory resistor device having multiple state-dependent resistances when induced with a state variable.

16. The multi-state memory resistor device of claim 15 wherein the state variable is maximum current across the convertible component, wherein a resistance from the multiple state-dependent resistances of the multi-state memory resistor device is a function of the maximum current.

17. The multi-state memory resistor device of claim 15 wherein the convertible component comprises at least one of: a plurality of metal filings, at least two metal balls in contact with each other, and a combination of a first metal and a second metal, wherein the first metal and the second metal are in direct or indirect contact.

18. The multi-state memory resistor device of claim 17 wherein the first metal is mercury, and the second metal is selected from a group consisting of iron, steel, tantalum, nickel, cobalt, manganese, chromium, aluminum, tin, lead, thallium, molybdenum, uranium, metals from platinum group, sodium, lithium, magnesium, zinc, cadmium, potassium, calcium, bismuth, antimony, copper, gold, alloys thereof, and combinations thereof.

19. The multi-state memory resistor device of claim 17 wherein the contact between the first metal and the second metal is indirect through an insulation layer.

20. The multi-state memory resistor device of claim 15 wherein the multiple state-dependent resistances are electrically reversible.

21. An electronic circuit arranged in crossbar architecture comprising one or more multi-state memory resistor device of claim 15.

22. An electronic circuit comprising:
a first electrode;
a second electrode; and
a multi-state memory resistor device comprising a convertible component characterized based on at least one of packing density, applied pressure, temperature, contact area or combinations thereof, wherein the convertible component converts into a multi state memory resistor device having multiple state-dependent resistances when induced with a maximum current across the convertible component, wherein a resistance from the multiple state-dependent resistances of the multi-state memory resistor device is a function of the maximum current.
